(19) United States
(12) Patent Application Publication
(10) Pub. No.: US 2013/0080953 A1
(43) Pub. Date: Mar. 28, 2013

(54) MULTI-AREA WIDGET MINIMIZING

(71) Applicant: Adrian X. Rodriguez, Durham, NC (US)

(72) Inventor: Adrian X. Rodriguez, Durham, NC (US)

(73) Assignee: INTERNATIONAL BUSINESS MACHINES CORPORATION, Armonk, NY (US)

(21) Appl. No.: 13/246,509

(22) Filed: Sep. 27, 2011

(51) Int. Cl. G06F 3/048

(52) U.S. Cl. 715/767; 715/835; 715/823

(57) ABSTRACT

A method for multi-area widget minimization, including: detecting a user selection action at a predetermined area within a widget in a user interface, wherein the widget includes a plurality of minimization policies that each correspond to a different predetermined area within the widget, wherein the user interface is displayed on a display device; selecting a policy corresponding to the predetermined area in which the user selection action is detected; and minimizing the widget in a manner determined by the policy for the predetermined area in which the user selection action is detected.

### BACKGROUND

When displaying multiple widgets on a screen or other display device, the screen can get cluttered. Widgets may also overlap or cover other widgets, making access to covered widgets more difficult when the widgets are in a full size state. Minimizing and repositioning a front widget allows a user to access widgets behind the front widget. Some conventional solutions allow a minimized state by clicking a minimization button on the widget to minimize the widget to a specific area of the active screen (rather than to a taskbar) such as the top right of the screen where the minimization button is located. When the user expands the widgets, such as by clicking a restore button, the widgets expand down to the previously opened state.

However, because the widgets typically minimize to the same area of the screen, multiple minimized widgets may clutter the screen or obscure other minimized widgets, making access to the minimized widgets difficult, as well. Accessing obscured widgets can often require a user to manually reposition the minimized widget to access a minimized widget behind a covered widget.

### SUMMARY

Embodiments of a system are described. In one embodiment, the system is a widget minimization system. The system includes: a user interface displayed on a display device; and a minimization engine configured to: detect a user selection action at a predetermined area within a widget in the user interface, wherein the widget includes a plurality of minimization policies that each correspond to a different predetermined area within the widget; select a policy corresponding to the predetermined area in which the user selection action is detected; and minimize the widget in a manner determined by the policy for the predetermined area in which the user selection action is detected. Other embodiments of the system are also described. Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a widget minimization system.

FIG. 2 depicts a schematic diagram of one embodiment of the user interface of FIG. 1.

FIG. 3 depicts a schematic diagram of one embodiment of the user interface of FIG. 1.

FIG. 4 depicts a schematic diagram of one embodiment of the user interface of FIG. 1.

FIG. 5 depicts one embodiment of a method for multi-area widget minimization.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated. In the preferred embodiment, there may or may not be a minimize or shrink button on each corner to the widget. Given the area of the current window on the screen, tapping any of the four corners would cause the window to minimize to the corner being tapped.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments present a system and method for multi-area widget minimization in an active portion of a user interface. More specifically, the system detects a user tap, click, or other selection action in a predetermined area of the widget and minimizes the widget based on a policy corresponding to the predetermined area. In one embodiment, the widget includes a plurality of policies, each corresponding to a separate predetermined area of the widget, which allows the user to minimize the widget according to multiple policies.

Conventional solutions allow users to minimize the widgets from one place, a minimize button, to a specific active portion of the screen. Generally, conventional widgets can only be minimized in one direction, and thus are only restored in one direction. Minimizing each widget to the same portion of the screen may result in cluttering up the user interface or obscuring other minimized widgets and making access to the obscured widgets difficult. Accessing the obscured, minimized widgets conventionally required the user to manually select the front widget and move it to another part of the screen. By minimizing the widgets to different parts of the screen based on multiple minimization policies that correspond to different predetermined areas of the widget, the system and method grant easier access to minimized widgets and help to clean up the user interface.

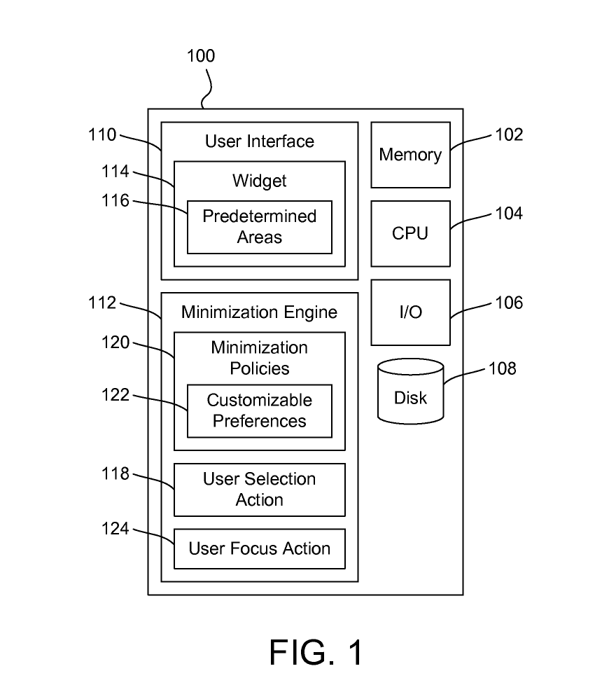

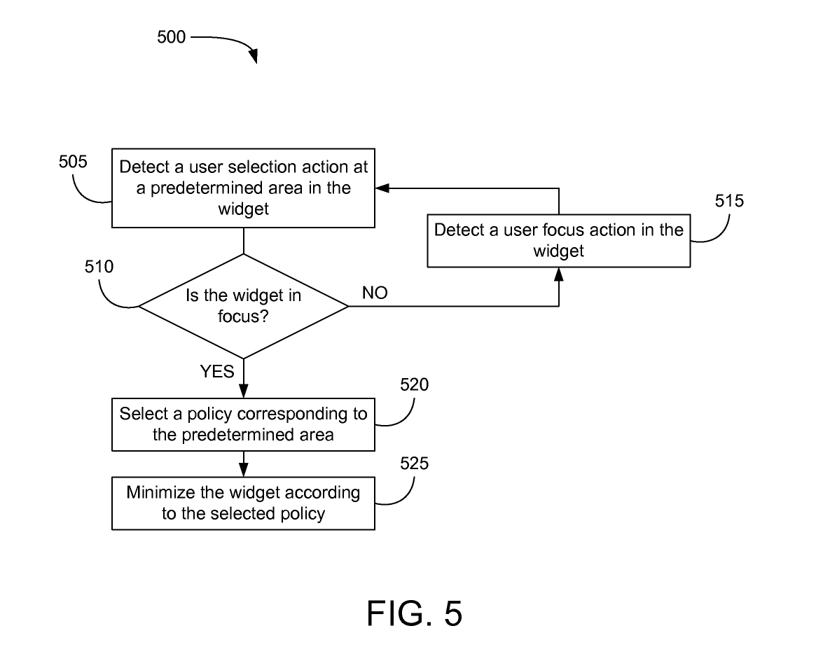

FIG. 1 depicts a schematic diagram of one embodiment of a widget minimization system 100. The depicted widget minimization system 100 includes various components, described in more detail below, that are capable of performing the functions and operations described herein. In one embodiment, at least some of the components of the widget minimization system 100 are implemented in a computer system. For example, the functionality of one or more components of the widget minimization system 100 may be implemented by computer program instructions stored on a computer memory device 102 and executed by a processing device 104 such as a CPU. The widget minimization system 100 may include other components, such as a disk storage drive 108, input/output devices 106, a user interface 110, and a minimization engine 112. Some or all of the components of the widget minimization system 100 may be stored on a single computing device or on a network of computing devices, including a wireless communication network. The widget minimization system 100 may include more or fewer components or subsystems than those depicted herein. In some embodiments, the widget minimization system 100 may be used to implement the methods described herein as depicted in FIG. 5.

In one embodiment, the widget minimization system 100 includes a user interface 110 to allow a user to interact with a computing device. The user interface 110 is displayed on an output device 106, such as a monitor or other display device, mobile device screen or other display device. The user interface 110 may be part of an operating system and may allow the user to interact with applications, programs, files, or other data associated with the computing device. The computing device may be any computing device, including a desktop computer, a laptop computer, a mobile device, or any other computing device.

In some embodiments, the user interface 110 includes a widget 114 that allows the user to perform various operations. The widget 114 may be associated with a program or an application. In one embodiment, the application includes widgets 114 that the user is able to open individually, including toolbars or other widgets 114 that may be minimized within the active screen of the application, rather than to an operating system taskbar or other designated minimization area outside of the active screen area.

In one embodiment, the widget minimization system 100 includes a minimization engine 112 for determining to which area on the active screen the widget 114 minimizes. The minimization engine 112 may determine the minimization areas where widgets 114 are minimized based on a plurality of minimization policies 120 that each correspond to a different predetermined area 116 within the widget 114. When a user selection action 118 occurs in one of the predetermined areas 116 in the widget 114, the minimization engine 112 selects the minimization policy 120 for the corresponding predetermined area 116 and minimizes the widget 114 according to the selected policy 120.

The predetermined areas 116 may correspond to any area of any size within the widget 114. In one embodiment, the predetermined areas 116 correspond to corners of the widget 114. In another embodiment, the predetermined areas 116 correspond to edges of the widget 114, including the sides, top, and bottom of the widget 114. When the user performs a user selection action 118 within a particular predetermined area 116, the minimization engine 112 selects the policy 120 corresponding to the particular predetermined area 116 and minimizes the widget 114 accordingly.

In one embodiment, the policy 120 for a given predetermined area 116 defines an area where the minimized widget 114 will be displayed in the user interface 110. Each policy 120 may define a different area in the user interface 110, such that the widget 114 may be minimized to multiple areas in the user interface 110. In one embodiment, the policy 120 defines the area for minimization as the predetermined area 116 in which the user selection action 118 is detected. Consequently, performing a user selection action 118 in a given predetermined area 116 minimizes the widget 114 to the corresponding predetermined area 116. In some embodiments, the widget 114 may be minimized to the entire predetermined area 116, such that the widget 114 is visually displayed to cover the full predetermined area 116 in the user interface 110. In some embodiments, the widget 114 may be minimized to a portion of the predetermined area 116 in which the user selection action 118 is detected, such that the widget 114 is only visually displayed to cover a portion of the predetermined area 116 in the user interface 110. In other embodiments, the widget 114 may be minimized to other areas of the active user interface 110 outside of the widget 114.

In other embodiments, the policy 120 may define the area for minimization to include areas of the user interface 110 other than the predetermined area 116. In one embodiment, the widget minimization system 100 allows the user to customize the widget minimization policies 120. The policies 120 may include customizable preferences 122 that allow a user to assign minimization locations to the widget 114 for each of the predetermined areas 116 associated with the widget 114. The customizable preferences 122 may also allow the user to define each of the predetermined areas 116. For example, the user may assign the predetermined areas 116 to be located in each corner of the widget 114 or at each edge of the widget 114.

In other embodiments, the user may assign the predetermined areas 116 to other areas of the widget 114.

In one embodiment, the minimization engine 112 may require the widget 114 to be in focus in the active screen before minimizing the widget 114. The user may perform a user focus action 124 detected by the minimization engine to bring the widget 114 into focus. In some embodiments, the user selection action 118 may act as a user focus action 124, and a second user selection action 118 may minimize the widget 114.

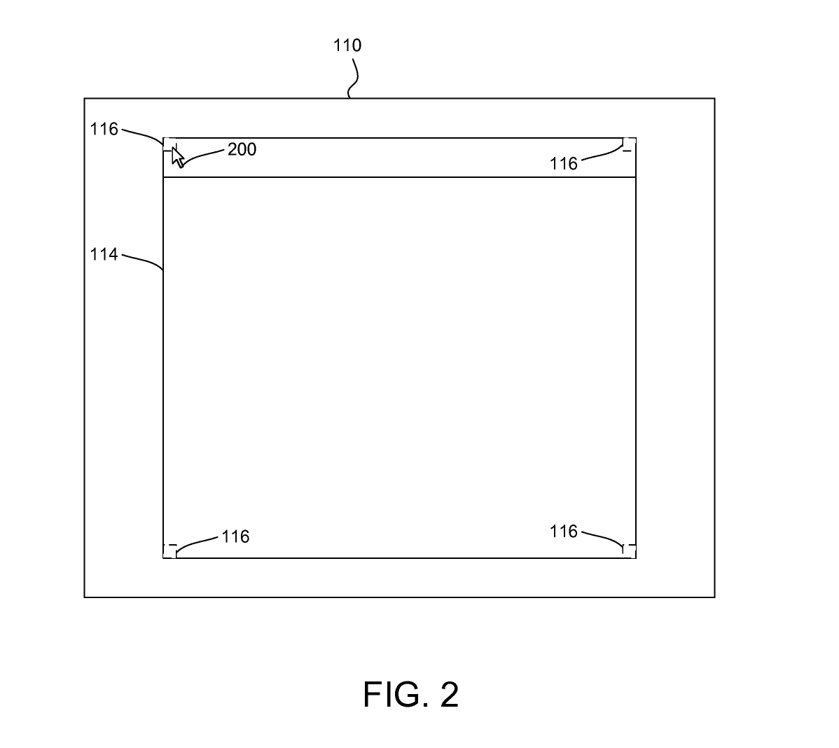

FIGS. 2-4 depict schematic diagrams of one embodiment of the user interface 110 of FIG. 1. While the widget minimization system 100 is described herein in conjunction with the user interface 110 of FIGS. 2-4, the widget minimization system 100 may be used in conjunction with any user interface 110 and any minimizable widget 114.

The user interface 110 may include applications with which the user may interact. In some embodiments, an application may be displayed using one or more windows on the display device. An application may include one or more widgets 114 that allow the user to perform various operations. In some embodiments, a widget 114 may be an application that is minimizable to an active portion of the screen. In one embodiment, an application includes multiple widgets 114 independent from each other, such that each widget 114 may be positioned, sized or minimized individually within a boundary of the widget 114.

In one embodiment, the predetermined areas 116 are located in each corner of the widget 114. In some embodiments, the predetermined areas 116 may be visibly defined on the widget 114, such that a user may be able to easily locate. In other embodiments, the predetermined areas 116 may not be visibly defined on the widget 114. The widget minimization system 100 may allow the user to customize the visibility of the predetermined areas 116. The widget minimization system 100 may also allow the user to customize the size, shape, and location of each of the predetermined areas 116. The widget minimization system 100 may also allow the user to determine a number of predetermined areas 116 for the widget 114. The widget 114 may include any number of predetermined areas 116 related to minimization policies 120 for minimizing the widget 114.

In the embodiment of FIG. 2, when the user performs a user selection action 118 within one of the predetermined areas 116, the widget minimization system 100 minimizes the widget 114 according to the policy 120 for the corresponding predetermined area 116. In some embodiments, the user moves a cursor 200 to one of the predetermined areas 116 in the widget 114 by interacting with a mouse or trackpad, and then performs a user selection action 118 by clicking within the predetermined area 116. In other embodiments, the user may simply perform a user selection action 118 by tapping on a touch screen in the predetermined area 116. In such an embodiment, no cursor may be displayed on the user interface 110, and the user may perform the user selection action 118 using a stylus, finger, or other method for performing actions on a touch screen.

In one embodiment, the location of the widget 114 in the user interface 110 may be defined using an xy-coordinate system. A set of four xy-coordinates may be used to describe an outer boundary of the widget 114. Specifically, the set of coordinates may define the location of four corners of the widget 114. The widget minimization system 100 may use the sets of xy-coordinates to determine the predetermined areas 116 for the widget 114. In one embodiment in which the predetermined areas 116 are located at the corners of the widget 114, the widget minimization system 100 may determine sets of coordinates to define the boundaries of each of the predetermined areas 116.

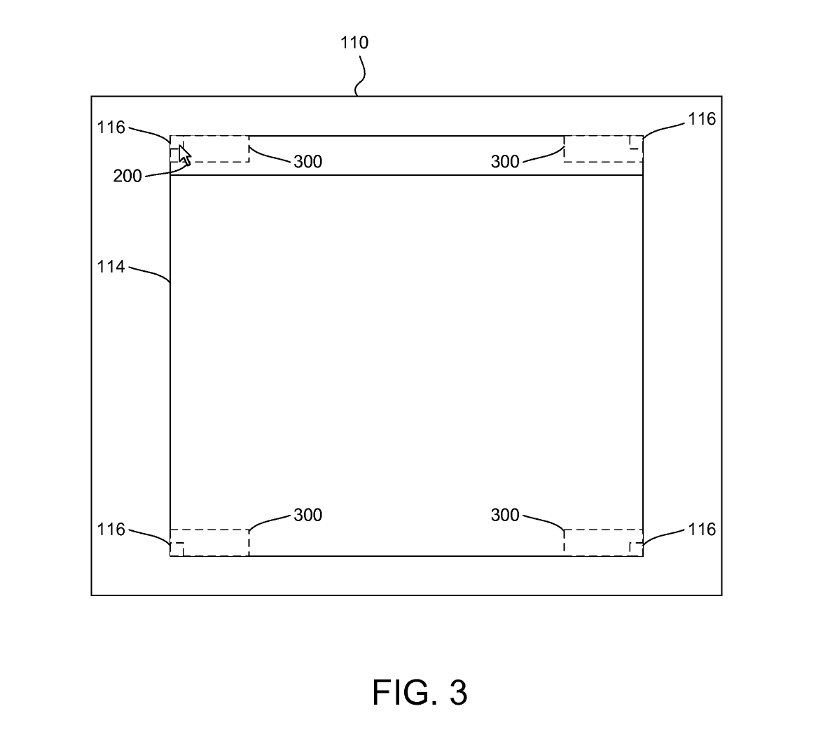

A user selection action 118 occurring within the boundary for a predetermined area 116 defined by the set of xy-coordinates causes the widget minimization system 100 to activate the policy 120 associated with that predetermined area 116. The widget minimization system 100 may determine that the user selection action 118 occurs within the boundary of the predetermined area 116 based on an xy-coordinate for the user selection action 118. In an embodiment in which the policy 120 is configured to minimize at least part of the widget 114 to the predetermined area 116, the widget minimization system 100 may minimize the widget 114 to one of the xy-coordinates in the set of coordinates for the predetermined area 116, as shown in FIG. 3. The policies 120 for each predetermined area 116 may define minimization locations 300 for the widget 114. If the user selection action 118 occurs outside the predetermined areas 116, the widget minimization system 100 does not activate any of the policies 120 corresponding to the predetermined areas 116.

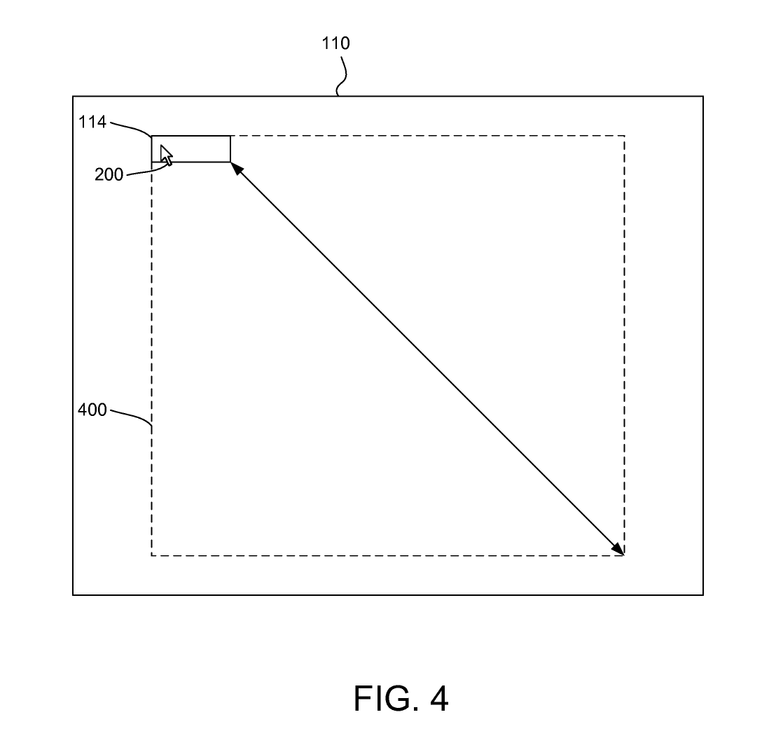

As shown in FIG. 4, the minimized widget 114 may also have a set of four xy-coordinates to define a boundary for the minimized widget 114. In one embodiment, the set of xy-coordinates for the minimized widget 114 are different from the set of xy-coordinates for the predetermined area 116. In another embodiment, one or more of the set of xy-coordinates for the minimized widget 114 are the same as one or more of the set of xy-coordinates for the predetermined area 116. In other embodiments, the set of xy-coordinates for the minimized widget 114 are all the same as the set of xy-coordinates for the predetermined area 116, such that the minimized widget 114 and the predetermined area 116 have the same boundary.

In one embodiment, the widget minimization system 100 determines the xy- coordinate of one corner of the minimized widget 114 based on the xy-coordinate of the user selection action 118, such that the xy-coordinate of the user selection action 118 becomes a corner of the minimized widget 114.

In one embodiment, the widget minimization system 100 assigns a corner of the minimized widget 114 to a corner of the predetermined area 116 based on the location of the predetermined area 116 within the widget 114. For example, if the user selection action 118 occurs in a predetermined area 116 in the top left corner of the widget 114, the widget minimization system 100 minimizes the widget 114 such that the top-left corner of the minimized widget 114 is located at the top left xy- coordinate of the predetermined area 116. If the user selection action 118 occurs in a predetermined area 116 in the bottom-right corner of the widget 114, the widget minimization system 100 minimizes the widget 114 such that the bottom right corner of the minimized widget 114 is located at the bottom right xy-coordinate of the predetermined area 116, etc.

In one embodiment, the widget minimization system 100 determines the location of the minimized widget 114 based on an edge of the predetermined area 116. For example, the minimized widget 114 may be assigned to a particular edge of the maximized widget 114 based on a location of the predetermined area 116 at the corresponding edge. Other embodiments of the widget minimization system 100 may minimize the widget 114 according to other policies 120.

In one embodiment, the widget 114 may be returned to an original state 400, including an original size and location for the widget 114, by selecting the minimized widget 114 or a certain area within the minimized widget. Consequently, the widget 114 may open in a direction determined by the location of the minimized widget 114 with respect to the original state 400.

FIG. 5 depicts one embodiment of a method 500 for multi-area widget minimization. Although the method is described in conjunction with the widget minimization system 100 of FIG. 1, embodiments of the method may be implemented with other types of widget minimization systems 100.

In one embodiment, the widget minimization system 100 detects 505 a user selection action 118 at a predetermined area 116 in the widget 114. The user selection action 118 may include clicking a mouse button or trackpad button, tapping a touch screen, using a shortcut key, or any other action that allows a user to perform a selection operation within the predetermined area 116.

In one embodiment, the widget minimization system 100 determines 510 if the widget 114 is in focus. The widget minimization system 100 may require the widget 114 to be in focus for the user selection action 118 to minimize the widget 114. The widget minimization system 100 may detect 515 a user focus action 124 to bring the widget 114 into focus in the user interface 110. The user focus action 124 may be a tap or click in the widget 114, for example. In some embodiments, the user selection action 118 may act as a user focus action 124 to bring the widget 114 into focus. In such embodiments, the widget minimization system 100 may require a second user selection action 118 before minimizing the widget 114. If the widget 114 is already in focus, the widget minimization system 100 implements the minimization policy 120 corresponding to the predetermined area 116 in which the user selection action 118 is detected. In some embodiments, the widget 114 does not need to be in focus for the widget minimization system 100 to minimize the widget. If the widget minimization system 100 is active and aware of user input, a window that is not in focus may be minimized and restored in such embodiments.

In one embodiment, the widget 114 includes multiple minimization policies 120 that each correspond to a different predetermined area 116 within the widget 114. Each policy 120 may define a widget 114 minimization location 300 for the corresponding predetermined area 116. The widget minimization system 100 selects 520 a policy 120 corresponding to the predetermined area 116 in which the user selection action 118 is detected. The widget minimization system 100 then minimizes 525 the widget 114 in a manner determined by the policy 120 for the predetermined area 116 in which the user selection action 118 is detected.

In one embodiment, the predetermined area 116 is a corner of the widget 114. The policy 120 corresponding to the corner in which the user selection action 118 is detected may map a minimization location 300 for the widget 114 to the corresponding corner of the widget 114. In one embodiment, the predetermined area 116 is an edge of the widget 114. The policy 120 corresponding to the edge of the widget 114 in which the user selection action 118 is detected may map a minimization location 300 for the widget 114 to the corresponding edge of the widget 114. In one embodiment, the policy 120 maps the minimization location 300 for the widget 114 to an exact location of the user selection action 118 along the corresponding edge for a predetermined area 116 at an edge of the widget 114. In other embodiments, the policy 120 may map the minimization location 300 for the widget 114 to another area of the widget 114 or active screen.

In one embodiment, the widget minimization system 100 allows the user to configure the policy 120 corresponding to each predetermined area 116 according to customizable preferences 122. The customizable preferences 122 may determine a minimization location 300 for each predetermined area 116 based on a user input. The customizable preferences 122 may allow the user to customize the size of the widget 114 in a minimized state. The customizable preferences 122 may additionally or alternatively allow the user to customize the size, number, and location of the predetermined areas 116. The customizable preferences 122 may allow the user to customize other aspects of the widget minimization system 100.

In one embodiment, after minimizing the widget 114, the widget minimization system 100 detects a second user selection action 118 to restore the widget 114 from a minimized state to an original state 400. The widget minimization system 100 may then restore the widget 114 to the original size and the original location in the user interface 110. When the widget 114 is restored to its original state 400, the widget minimization system 100 then waits for further user selection actions 118.

An embodiment of a widget minimization system 100 includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to monitor a pointer movement in a web page. The web page displays one or more content feeds. In one embodiment, operations to report the pointer movement in response to the pointer movement comprising an interaction gesture are included in the computer program product. In a further embodiment, operations are included in the computer program product for multi-area widget minimization.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product, comprising:
a computer readable storage medium to store a computer readable program, wherein the computer readable program, when executed by a processor within a computer, causes the computer to perform operations for multi-area widget minimization, the operations comprising:
detecting a user selection action at a predetermined area within a widget in a user interface, wherein the widget comprises a plurality of minimization policies that each correspond to a different predetermined area within the widget, wherein the user interface is displayed on a display device;
selecting the policy corresponding to the predetermined area in which the user selection action is detected; and
minimizing the widget in a manner determined by the policy for the predetermined area in which the user selection action is detected.

2. The computer program product of claim 1, wherein the predetermined area is a corner of the widget, wherein the policy for the corner maps a minimization location for the widget to the corresponding corner.

3. The computer program product of claim 1, wherein the predetermined area is an edge of the widget, wherein the policy for the edge maps a minimization location for the widget to the corresponding edge.

4. The computer program product of claim 3, wherein the policy further maps the minimization location for the widget to an exact location of the user selection action along the corresponding edge.

5. The computer program product of claim 1, wherein the computer readable program, when executed on the computer, causes the computer to perform additional operations, comprising:
determining that the widget is out of focus in the user interface; and
detecting a user focus action in the widget prior to detecting the user selection action, wherein the user focus action brings the widget into focus in the user interface.

6. The computer program product of claim 1, wherein the computer readable program, when executed on the computer, causes the computer to perform additional operations, comprising:
detecting a second user selection action to restore the widget from a minimized state to an original state; and
restoring the widget to the original size and an original location in the user interface.

7. The computer program product of claim 1, wherein the computer readable program, when executed on the computer, causes the computer to perform additional operations, comprising:
configuring the plurality of policies according to customizable preferences, wherein the customizable preferences determine a minimization location for the widget for each predetermined area based on a user input.

8. The computer program product of claim 1, wherein the computer readable program, when executed on the computer, causes the computer to perform additional operations, comprising:
highlighting the predetermined area in the user interface, wherein the predetermined area is visible on the display device.

9. A method for multi-area widget minimization, comprising:
detecting a user selection action at a predetermined area within a widget in a user interface, wherein the widget comprises a plurality of minimization policies that each correspond to a different predetermined area within the widget, wherein the user interface is displayed on a display device;
selecting the policy corresponding to the predetermined area in which the user selection action is detected; and
minimizing the widget in a manner determined by the policy for the predetermined area in which the user selection action is detected.

10. The method of claim 9, wherein the predetermined area is a corner of the widget, wherein the policy for the corner maps a minimization location for the widget to the corresponding corner.

11. The method of claim 9, wherein the predetermined area is an edge of the widget, wherein the policy for the edge maps a minimization location for the widget to the corresponding edge.

12. The method of claim 11, further comprising highlighting the predetermined area in the user interface, wherein the predetermined area is visible on the display device.

13. The method of claim 9, further comprising:
determining that the widget is out of focus in the user interface; and
detecting a user focus action in the widget prior to detecting the user selection action, wherein the user focus action brings the widget into focus in the user interface.

14. The method of claim 9, further comprising:
detecting a second user selection action to restore the widget from a minimized state to an original state; and
restoring the widget to the original size and an original location in the user interface.

15. The method of claim 9, further comprising:
configuring the plurality of policies according to customizable preferences, wherein the customizable preferences determine a minimization location for the widget for each predetermined area based on a user input.

16. A widget minimization system, comprising:
a user interface displayed on a display device; and
a minimization engine configured to:
detect a user selection action at a predetermined area within a widget in the user interface, wherein the widget comprises a plurality of minimization policies that each correspond to a different predetermined area within the widget;
select the policy corresponding to the predetermined area in which the user selection action is detected; and
minimize the widget in a manner determined by the policy for the predetermined area in which the user selection action is detected.

17. The system of claim 16, wherein the predetermined area is a corner of the widget, wherein the policy for the corner maps a minimization location for the widget to the corresponding corner.

18. The system of claim 16, wherein the predetermined area is an edge of the widget, wherein the policy for the edge maps a minimization location for the widget to the corresponding edge.

19. The system of claim 16, wherein the minimization engine is further configured to:
determine that the widget is out of focus in the user interface; and
detect a user focus action in the widget prior to detecting the user selection action, wherein the user focus action brings the widget into focus in the user interface.

20. The system of claim 16, wherein the minimization engine is further configured to:
configure the plurality of policies according to customizable preferences, wherein the customizable preferences determine a minimization location for the widget for each predetermined area based on a user input.
